(19) United States
(12) Patent Application Publication
(10) Pub. No.: US 2020/0380589 A1
(43) Pub. Date: Dec. 3, 2020

(54) System & Method For On-Line Auction Of A Trade-In Of A Customer Product Incident To Real-Time Negotiation Of A Replacement Product

(71) Applicants: Jerry W. Clark, Vero Beach, FL (US); Lynnette S. Clark, Sebastian, FL (US)

(72) Inventors: Jerry W. Clark, Vero Beach, FL (US); Lynnette S. Clark, Sebastian, FL (US)

(21) Appl. No.: 16/423,089

(22) Filed: May 27, 2019

(51) Int. Cl. G06Q 30/06; G06Q 30/02; G06Q 20/22

(52) U.S. Cl. CPC G06Q 30/0641; G06Q 30/0609; G06Q 20/223; G06Q 30/0278; G06Q 30/0613

(57) ABSTRACT

A hybrid peer-to-peer computer-implemented network or system, for connecting dealers and merchants together, in real-time, to effect a wholesale auction of a product among network members. The network or system is executable with “Software-as-a-Service” application on a computer or mobile device, having an internet connection. The application is based upon a standardized appraisal model for a product to be taken in trade on a product offered for sale by a dealer. The network or system includes a subscriber registration process for creation of a subscriber profile, a database for organization of product features and characteristics, and a series of filters for delineation of a subscriber's preferences. Each subscriber is represented as a node on the network. At any time a subscriber can participate as a seller or a potential buyer and create an appraisal of the product to be taken in trade, or compute a bid on the product.

### CROSS-REFERNCE TO RELATED APPLICATION

The application claims priority to Provisional Patent Application Ser. No. 62/762,978, Filed May 25, 2018

### BACKGROUND OF THE INVENTION

### 1. Field of the Invention

This invention relates to a system and application, hosted on a remote server, for connection of system subscribers having a community of interest in the wholesale purchase and sale of goods which have a specific digital profile. More specifically, the system and method involve conducting a peer-to-peer wholesale auction between application subscribers, for products such as a motor vehicle to be taken in trade by a network subscriber, based upon a verified appraisal of products offered for sale. The subscriber registration process includes creation of a subscriber profile and a menu for the subscriber's designation of product preferences. The application is “transaction neutral” in that at any one time a subscriber can participate as a seller or a potential buyer and utilize resources available on the application to create an appraisal of the product to be taken in trade, or to bid on the product.

In one of the preferred embodiments of this invention, the system creates in real-time and distributes on-line a vehicle specific digital profile of an appraised vehicle (also “VSHP”) to potential wholesale buyers for the appraised vehicle, concurrent with a consumer trade-in transaction of such vehicle. The vehicle specific digital profile can include information/data from an “On-Board Diagnostic” (also “OBD”) which directly communicates with the system, preferably through a wireless connection. In addition to the verification of the vehicle information (confirmation of the original equipment inventory), the sensor connection to the On-Board Diagnostic port, is used to collect vehicle data from a test drive (of at least 5 and preferable 10 minute duration). The test drive data (also “raw data”) is available and accessible as a print out or in digital report. In addition to enhancing the credibility of the appraisal the test drive information can be bundled with an advertisement for the vehicle, or separately marketed to the consumer as an integral part of a report of the vehicle ownership and service history (e.g. as hybrid AutoCheck, VINCheckPro, or CarFax)

### 2. Description of the Prior Art

As the prices of new vehicles (e.g. cars, vans, trucks, motorcycles, etc.) continue to rise, the consumer demand for used vehicles is increasing. Some consumers view the purchase of a used vehicle as a means of acquiring their vehicle of choice without having to incur the expenses associated with the purchase of a new vehicle. Purchasing used vehicles is also becoming a more attractive option as the quality of new vehicles improve; the downstream effect of improved new vehicle quality means that used vehicles typically stay on the road longer. Certification programs being offered by vehicle manufacturers also serve to alleviate consumers' fears of purchasing poor-quality used vehicles. These programs have also contributed to increased sales of used vehicles.

The supply of used vehicles has also increased dramatically in recent years due to the increased popularity of leasing as an alternative to purchasing new vehicles. When the leases expire on these vehicles, the vehicles typically add to the supply of used vehicles available for sale to consumers.

The pricing of used vehicles can be a considerably more complex task than the pricing of a new vehicle. While the condition of new vehicles (both the mechanical condition and visual condition, for example) does not typically differ significantly from vehicle to vehicle, the condition of used vehicles often does. Different factors relating to the condition of a used vehicle are taken into account when pricing the vehicle and each of these factors can have a significant effect on the ultimate price of the vehicle. Many prior art systems and pricing techniques that are used to price new vehicles assume that the vehicles are in “perfect” condition. These systems and techniques cannot be used to effectively or accurately price used vehicles since the condition of used vehicles often varies significantly from vehicle to vehicle.

### Pricing and Selling Used Vehicles: the Consumer's Perspective

Historically, there have been primarily three (3) common methods for a consumer to sell a used vehicle. One common method is to sell the used vehicle to a new vehicle dealer. This is typically done by way of a “trade-in” transaction in which the consumer sells his used vehicle to the new vehicle dealer for a negotiated amount. That amount is then subsequently deducted from the cost of a new vehicle being purchased or leased.

Another common method is to sell the used vehicle to a used vehicle dealer. The consumer can sell his used vehicle to the used vehicle dealer for cash or for a discount that can be applied towards the purchase or lease of another used vehicle.

Alternatively, a consumer might sell the used vehicle in a private transaction with another consumer. A potential buyer might be found through “word-of-mouth” means, or commonly through classified advertisements placed in newspapers, in used vehicle magazines, or online, for example.

Unfortunately, these methods for selling vehicles can be time-consuming and inefficient. All of these methods typically require a certain amount of negotiation between the buyer and seller. From the consumer's point-of-view, it may be difficult to predict the ultimate sale price of the vehicle, or what it ought to be based on the current demand for the vehicle, since the consumer typically does not have access to the same information that a dealer will have access to for determining the fair market value of the vehicle. For example, the consumer may not be aware that his vehicle may be in extremely high demand in a particular month, and therefore might have an abnormally high market value that month. While the consumer might be able to more accurately assess the current market value of his vehicle by having it appraised at numerous vehicle dealers, the process of obtaining numerous quotes can be inconvenient and time-consuming.

The ultimate sale price may vary depending not only on the market demand for such vehicles but also on the consumer's own ability to negotiate a sale price. Some consumers are not comfortable with having to negotiate a sale price for their vehicles and may indeed be at a disadvantage if the potential buyer is a better negotiator. Consumers who choose not to negotiate at all often end up selling their vehicle at a sub-optimum value.

In summary, some consumers view the selling of their vehicles as pressure-filled situations where they must make significant selling decisions with incomplete information.

There may also be disadvantages related specifically to the sale of vehicles in private (consumer-to-consumer) transactions. For example, potential purchasers may feel less willing to buy vehicles in private transactions for fear of fraud, quality problems, and inconveniences that must be endured when trying to find a buyer for the vehicle, or when performing tasks that must be carried out to complete the transaction (e.g. complying with regulatory requirements).

Recently, with the increasing popularity of the Internet, several online mechanisms for the sale and purchase of vehicles are also now available to consumers. Online auction web sites (e.g Ebay) may be used by consumers to sell and purchase a wide variety of goods. For example, when a consumer wishes to sell an item, he can post a description of that item on the web site. Potential purchasers can bid for the item, allowing the consumer to sell the item to the highest bidder.

When a vehicle is to be sold through such online auction web sites, the transaction is typically consumer-to-consumer, and not consumer-to-dealer. As a result, the disadvantages related to private consumer-to-consumer transactions also typically apply to online auction sales. Furthermore, because it may be particularly difficult to reach local buyers, high delivery costs and the difficulties and inconveniences which may arise when arranging for an inspection of the vehicle for sale may limit the use of online auction web sites by consumers.

Once a description for an item has been posted on the online auction web site there is typically a period in which the consumer will wait before the item is sold in order to increase the likelihood of obtaining a better price. The ultimate sale price will also depend on the number of potential buyers who have seen the posting and who have decided to place a bid on the item. Typically, the less potential buyers who have bid on the item, the less likely a fair market price has been offered for the item. Thus, online auction web sites may not be a viable alternative for consumers who do not wish to endure the delay associated with the sale of the item, particularly if there is no guarantee that their posting will attract a desirable number of bids.

Tools to facilitate the appraisal of used vehicles also exist in the prior art. For example, traditionally, the Black Book and Kelley Blue Book have been used by vehicle dealers and consumers to value used vehicles. These two publications are published periodically and provide estimated wholesale values on used vehicles based upon the year, make of the vehicle for sale, mileage, options, accessories, and other aspects relating to the vehicle's overall condition. While these books may be helpful in determining a value for the vehicle for sale, the value of such reference materials is merely an estimate, and not a price that must be honored by any vehicle dealer. The values of vehicles supplied by these books are not continuously updated. Therefore, current demand, (or lack thereof), of a specific vehicle at any given time are not reflected in these values. The values in the books also do not reflect the current demand (or lack thereof) of a specific vehicle in a particular geographical area.

A limited number of vehicle dealers offer online appraisals of vehicles through their own private vehicle dealer web sites. A consumer can enter details on the vehicle he wishes to sell on an HTML-based form. When the dealer receives the appraisal or pricing request, the dealer then considers the details received and provides the consumer with a quote for the vehicle. However, this quote may not accurately reflect the value that other vehicle dealers might offer for the same vehicle. The consumer cannot expect a different dealer to honor the quote, and quotes provided by one dealer are not provided to other dealers. The consumer typically must sell the vehicle to the dealer providing the quote in order to obtain that price even if, for other reasons, the consumer would prefer to sell the vehicle to a different dealer. This can also be a slow process if the dealer receiving the appraisal request does not respond to the consumer in a timely manner, In order to better estimate the demand for a user's vehicle at a given time in a given geographical location, multiple appraisals are typically obtained. However, as with the process of obtaining separate “in-person” appraisals from multiple vehicle dealers, obtaining separate online appraisals can be equally, if not more time-consuming.

### Pricing and Selling Used Vehicles: the Dealer'S Perspective

While the consumer primarily sells or purchases used vehicles through new or used vehicle dealers, there exists an elaborate network of businesses and individuals that make remarketing of millions of used vehicles in North America each year possible. Used vehicles make their way from various sources (e.g. dealers, factories, fleet operators, leasing organizations, consumers, etc.) to consumers through a variety of channels. Automobile auctions are typically the largest wholesale intermediary, and dealers are typically the largest source of auction vehicles. Vehicle manufacturers, fleet operators, financial institutions, captive finance subsidiaries and rental companies are other sources of auction vehicles. These vehicles are, in turn, often purchased by other vehicle dealers for resale to consumers. However, the purchase of used vehicles through the auction process can be a time-consuming process, and typically requires the purchasing dealers to predict, sometimes inaccurately, the future demand for the vehicles being auctioned at the time of the auction. As the consumer demand for used vehicles increases, vehicle dealers of used vehicles are seeking more efficient ways of meeting this demand

Before a dealer obtains a used vehicle from a consumer (e.g. as a “trade-in” vehicle in a transaction being negotiated), the dealer is typically required to appraise the vehicle to aid in the calculation of an acceptable purchase price. Traditionally, as explained earlier, publications such as the Black Book and Kelley Blue Book have been used by vehicle dealers to value used vehicles. However, the values of vehicles supplied by these books are not continuously updated and may, in some cases, be considerably outdated.

Furthermore, the values of vehicles supplied by these books are merely an estimate of the current value of the vehicles. There is no guarantee that a used vehicle will be purchased by another consumer or another dealer at the estimated value. Not only does the value of a given vehicle depend on the demand for the specific type of vehicle at a given time, the demand for any given vehicle may differ across dealers serving different geographical areas or segments of the populations for example, which in turn is reflected in different valuations that may be placed on the vehicle by different dealers. As a further example, a specific dealer may have customers who have expressed an interest in buying a specific type of used vehicle that is not currently stocked by the dealer; that dealer, having already made contact with interested customers, would likely place a higher value on a used vehicle of the desired type than other dealers who are not in contact with any interested customers.

Accordingly, when a dealer is faced with the task of pricing or valuing a used vehicle being obtained from a consumer as a “trade-in”, for example, there are only a limited number of ways of obtaining an accurate “real-time” valuation for the vehicle. If the dealer does not wish to stock the used vehicle in his own dealership, the dealer may want to explore the possibility of reselling the vehicle to a different dealer or wholesaler. The dealer may phone other dealers or wholesalers to determine the vehicle's resale value. However, this is a time-consuming process and as a result typically only a small number (e.g. 2-3) of enquiries are made, which may not result in an accurate valuation, or the best resale value that may be available for that particular vehicle.

It is also difficult to provide an adequate description of the used vehicle in order to have the vehicle priced, for example over the telephone. Many factors associated with a used vehicle's condition, age, owner, type, and options for example, are often taken into account in the vehicle's price, and such information needs to be accurately conveyed in the description of the vehicle. Dealers may be hesitant to offer a guaranteed purchase price for a used vehicle being offered for resale without a complete description of the vehicle. Furthermore, different dealers or wholesalers may place different weights on different factors, resulting in different prices. Accordingly, where only a small number of enquiries are made, it may be more difficult for a dealer to find the best resale value for the used vehicle being purchased.

Up to now the dealer trade-in valuation has been based upon extrinsic factors and processes, specifically, soliciting information from other dealers or data mining sources which collect wholesale prices paid for used vehicles. The reliance exclusively upon extrinsic sources of valuation data is, at best, “old news”.

Notwithstanding an appreciation of such limitations and deficiencies, the attempted adaptation of an ecommerce model to the wholesale buying and selling of used motor vehicles (based upon the total volume of such transactions) has changed very little over the years, despite the proliferation of internet transactions for retail commerce.

On occasion, a number of systems, based upon an ecommerce model, have been suggested. Unfortunately, for one reason or another, they have all fallen short. The following are representative of these unsuccessful efforts.
US 2012/0330723, to Hedy, entitled “Distributed System & Method of Used Vehicle valuation”, published Dec. 27, 2012,

The system proposed by Hedy was based upon a subscriber dealer population link to a system database, and the population of the database with actual transaction data relative to its own wholesale purchase and sale. The Hedy system contemplates direct access to dealer management system via online communication. These data files of the system can be accessed by a system subscriber, and the subscriber “mined the data” for the information of interest.
US 2003/0200151. To Ellenson, entitled “System & Method For The Real-Time Pricing, And Sale Of Used Vehicles”, published Oct. 23, 2003

The system proposed by Ellenson is based upon a system and method for collecting data from buyers in constructing appraisal profiles and for calculating, in real time, a guaranteed price for a used vehicle having specific attributes as described by a seller based upon an appraisal profile. The objective in this data collection and pairing is to arrive at an appraisal were the used vehicle is offered at a guaranteed price.

In each of Hedy and Ellenson, the collection of data from subscribers, and possibly additional sources, must first be processed before an appraisal figure can be assigned to a specific vehicle. In each case, the information collected is derived from disparate sources, which can be less than current. The data in each system must be constantly refreshed and the sources of such information may be less than objective.

Accordingly, the trade-in valuation for used cars has up to now been largely subjective or based upon archival information (which is generally stale) or a combination of both. More often than not, a trade-in valuation rarely if ever generates a detailed report that comports with a uniform standard and the valuation can be skewed or biased based upon the preferences or emphasis of a market or particular brand. Thus, there continues to exist a need to provide a reliable standard that is based upon a trade or industry consensus which enjoys the confidence of the participants.

Objects of the Invention

Accordingly, it the principal object of this invention to remove the above as well as related deficiencies in the prior art.

More specifically, it the principal object of this invention to provide a hybrid, peer-to-peer network or system having accessory resources hosted on a remote server based upon a subscriber defined profile, wherein the subscriber defined profile is based upon its business focus and upon preferences in a subscriber enrollment profile.

It is another object of this invention to provide a system and application wherein each subscriber designates one or more data fields corresponding to its inventory needs and wholesale purchasing preferences; specifically, the wholesale purchasing preferences for used automobiles.

It is another object of this invention to provide a system and application, hosted on remote server, to disseminate a subscriber posting of used automobiles to be purchased or contemplated as being taken in trade for another vehicle prior to its acceptance of the trade pursuant to the retail purchase of another vehicle.

It is yet another object of this invention to provide a system and application, hosted on a remote server, wherein the subscriber posting of used automobiles available for sale (“push for bid”) has been professionally appraised in accordance with the system standards in the industry.

It is still yet another object of this invention to provide a system and application, hosted on a remote server, wherein the subscriber posting of a product available for sale (“push for bid”) solicits subscriber bids and/or counteroffers based upon a push for bid that has been professionally appraised; and the system includes subscriber resources for response to a “push for bid”, to evaluate the reasonableness of the appraisal, and submit a counter-offer.

It is yet another object of this invention to provide a system and application, hosted on a remote server, wherein the offer to sell includes a verified appraisal, and the system includes subscriber resources for response (bid) for evaluation of the reasonableness of the appraisal based upon a bidder's unique market.

It is yet another object of this invention to create and distribute a vehicle specific digital profile (also “VSHP”) incident to an appraisal of a vehicle, and, alternatively, as an application for use by vehicle re-sellers to create and distribute a vehicle specific digital profile (also “VSHP”) to append to a re-seller's on-line advertising of a vehicle.

### SUMMARY OF THE INVENTION

The above and related objects of this invention are achieved with a hybrid peer-to-peer (“H-P2P”) network or system for connecting dealers and merchants to one another, in real-time, to effect the sale of a product to one another based upon a standardized appraisal model for the product offered for sale. More specifically, the system and method can involve, for example, conducting a peer-to-peer wholesale auction between application subscribers for a product (e.g. vehicle or jewelry) to be taken in trade by an application subscriber based upon a verified appraisal of the products offered for sale. It is understood that a subscriber, or a customer of a subscriber, can also be the owner of the product put up for auction on the network. The network or system includes a subscriber registration process for creation of a subscriber profile, a date base for organization of product (e.g. vehicle) features and characteristics, and a series of digital filters for delineation of a subscriber's designation of preferences based upon the vehicle or product features and characteristics. Each subscriber is represented as an independent node on the hybrid peer-to-peer (“H-P2P”) network or system. Accordingly, the network operation, and the subscriber application for subscriber access to the network, are “transaction neutral”, in that at any one time a subscriber can participate as a seller, or a potential buyer; and, utilize resources, available on the application to create an appraisal of the product to be taken in trade, or utilize such resources to calculate a bid on the product.

Each of the dealer and merchant subscribers on this network, thus, have a shared community of interest in the trade or business being transacted on this network by virtue of their subscription to the hybrid peer-to-peer (“H-P2P”) network or system. Participation in this community requires pre-registration, with each registered dealer and merchant (also “Subscriber”) completion of a subscriber profile, and the selection of preference (e.g. digital filters), which controls and selectively limits their access to and dissemination in real-time alerts to the Subscribers.

Each Subscriber operates essentially independent of one another as an equivalent peer or node on the network; each Subscriber has its identity concealed from other Subscribers (other than their account/subscriber number) and has both seller and buyer privileges. In an automobile dealer network model, for example, a consumer transaction typically includes a trade-in of a consumer vehicle toward the purchase of another vehicle from the same dealer. The dealer taking the consumer vehicle in trade may not desire to place the trade-in in the dealer inventory (for whatever reason). In this system, the dealer creates a digital appraisal of the proposed trade-in based upon a standardized appraisal model and offers or solicits offers for the trade-in, in real-time, to wholesale buyers on the Subscriber network (also “Push for Bid”). The Push for Bid, or solicitation of bids, is based upon a standardized appraisal created by Subscriber and circulated on the system. This Push for Bid, or solicitation of bids, does not include an offering price, only the objective and subjective data on the standardized appraisal report.

This Push for Bid is also automatically archived in an originating dealer or Appraiser Subscriber log. The log includes the Push for Bid, the Black Book value of the appraised vehicle, and appraiser notes relative to the appraised vehicle. A Subscriber recipient can accept the Push for Bid or submit a counteroffer.

If the vehicle is sold to a Subscriber recipient, financial arrangements are thereafter made to transfer title from the Appraiser Subscriber, or directly from the customer, to the winning Subscriber recipient; and arrange for transportation of the vehicle to the Subscriber recipient. Alternatively, the trade-in can be added to the Appraiser Subscriber inventory or the consumer is free to reject the dealer's trade-in valuation.

In the latter case, a trade-in vehicle profile is created on the system and the consumer can shop for a better deal at another dealership. Where a consumer shops around for a better trade-in deal and another appraisal of the vehicle is made by a different Subscriber dealer, the new appraisal is added to the trade-in vehicle profile which has been created and maintained on the system. The vehicle trade-in profile created on this system permits a Subscriber, for the first time, to track a vehicle history based upon to a Subscriber's competing offers and for a given vehicle.

In the preferred embodiments of this invention, this invention can be packaged, and distributed to subscribers as a “Software-as-a-Service” (“SaaS”) application, which is executable on a computer, or mobile device, having an internet connection. The SaaS application is preferably implemented on a Cloud Service provider platform (e.g. Oracle Integration Cloud) to create an on-line interactive marketplace among SaaS subscribers for the execution of a wholesale transaction for automobiles which are to be taken in-trade toward the purchase of a replacement vehicle from a dealer's existing inventory. In the preferred embodiments of this invention, the SaaS application is also connected via a set of sub-routines and protocols to external applications such as The Black Book (wholesale equivalent of the Kelly Blue Book), Experian (to run credit checks and background histories, chain of ownership of vehicles), and available data from various Dealer Management Systems (DMS), and thereby integrates such data from these external sources into the creation of a verified appraisal of a trade-in and/or calculation of a bid on the trade-in.

In another one of the preferred embodiments of this invention, the system creates and distributes, in real-time, an on-line Vehicle Specific Digital Profile (also “VSHP”) for the appraised vehicle for posting on the system and circulation to potential wholesale buyers of the vehicle concurrent with a consumer trade-in vehicle. The vehicle specific digital profile can include information/data from an “On-Board Diagnostic” (also “OBD”) which directly communicates with the system, preferably through a wireless connection. In addition to the verification of the vehicle information (confirmation of the original equipment inventory), the sensor connection to the On-Board Diagnostic port is used to collect vehicle data from a test drive (of at least 5 and preferably an 8-10 minute duration). The test drive data (also “raw data”) is available and accessible as a print out or as a digital report. In addition to enhancing the credibility of the appraisal, the test drive information can be bundled with an advertisement for the vehicle or separately marketed to the consumer as an integral part of a report of the vehicle ownership and service history (e.g. as hybrid AutoCheck, VINCheckPro, or CarFax)

### BRIEF DESCRIPTION OF THE DRAWINGS

FIG. 1 depicts a representative hybrid peer-to-peer (“H-P2P”) network for implementation of the SaaS (Software as a Service) application of this invention through a Cloud Service Provider Platform. More specifically, FIG. 1 illustrates a hybrid peer-to-peer network have an infinite number of subscribers wherein the peer-to-peer interaction is facilitated by information accessible from the subscriber profile in the subscriber module maintained in the system server.

FIG. 2 depicts the registration application page on a the registration module of the system server, wherein a system subscriber (also “dealer” or “wholesaler”) creates a profile containing subscriber specific information (also “profile”), and a series of “filters”, delineating certain product preferences for receipt of targeted alerts corresponding to such preferences.

FIG. 3 depicts a SaaS application screen menu (also “Home Page”) on an electronic communication device for a subscriber connection of the communication device (e.g. work station, IPad) having internet connectivity to the server for the H-P2P network of this invention. The Home Page includes the usual navigation options (e.g. sign-in, search, etc.). The Home Page also permits subscriber profile modification of the subscriber preferences (“filters”) to permit the subscriber to add or reduce the receipt of subscriber alerts on the network.

FIGS. 4A, 4B, 4C, 4D and FIG. 7 depict the sequential collection of vehicle specific information by an Appraising Subscriber incident to its creation of a digital vehicle profile for preparation of the verified vehicle appraisal. More specifically:

FIG. 4A depicts the initial validation of the vehicle identification, specifically, the correspondence of the Vehicle Identification Number (also “VIN”) with the vehicle.

FIG. 4B depicts the further collection of objective vehicle information, specifically, vehicle mileage and vehicle performance (test drive) or dynamic vehicle operation.

FIG. 4C depicts the further collection of objective vehicle information, specifically, the operational interior systems (power windows, A/C).

FIG. 4D depicts the further collection of objective vehicle information, specifically, photographs of the four (4) exterior quadrants of the vehicle.

FIG. 5 depicts a flow chart of the cataloging of vehicle defects.

FIG. 6 depicts a flow chart for recording (via input into text boxes) for inclusion of an appraiser narrative re. appraiser qualitative impressions.

FIG. 7 depicts a flow chart of the system recording of the appraisal in the system relational data base, for later retrieval and storage in the vehicle log.

FIG. 8 is the endorsement of the appraisal by a professional.

FIG. 9 is a flow chart depicting the Appraising Subscriber dissemination of the verified appraisal to Member Subscriber on the H-P2P network subscribers.

FIG. 10 is a flow chart depicting the negotiation of the wholesale auction of the appraised vehicle.

### DETAILED DESCRIPTION OF THE INVENTION INCLUDING PREFERRED EMBODIMENTS

Definitions—Preliminary to a description of the preferred embodiments of this invention it is appropriate and helpful to first define a number of terms/phrase which are used in reference to the systems and methods contemplated herein.

The term/phase “Peer-to-Peer” (also “P2P” and “System”) as used herein is intended to describe a self-organizing system of equal, autonomous entities (peers) which aims for the shared usage of distributed resources in a networked environment, while avoiding a centralized network server.

The term/phase “Hybrid Peer-to-Peer” (also “H-P2P”) as used herein is intended to describe a system based upon a peer-to-peer network having a central server that helps Peers find each other, specifically, target a Subscriber based upon a Subscriber preferences (e.g. Subscriber set of digital filters).

The term/phase “Relational Data Base” as used herein is an application resident upon a network server for storing and organizing information (data) from a Subscriber and information relating to a Subscriber's products. The database matches data by using identical information that is found within the data set. The resulting groups of data are organized and are much easier for network subscribers to understand and access. For example, within the context of this invention, such a database can have all information about a product characteristics or features from an auto manufacturer. This information can be grouped by year, or by sale price, or product options etc. Such a grouping uses the relational model (a technical term for this is schema). The term “relational database” often refers to this type of software

The term/phase “On-Line Wholesale Auction” and/or “On-Line Wholesale Auction For Used or Existing Products”, as used herein is intended to describe a decentralized marketplace which has been organized and maintained upon a “Hybrid Peer-to-Peer Network” (also “H-P2P”) for the sale and/or purchase of consumer products (e.g. gems, automobiles, etc.) taken in trade by network merchants and dealers, toward the purchase of the product (typically a new or newer product) from a network merchant or dealer.

The term/phase “Subscriber” or “Net Member Subscriber” as used herein is intended to describe a merchant and/or dealer, who is a registered participant (also “Member”) in the Hybrid Peer-to-Peer Network and thereby is authorized to engage in an On-Line Wholesale Auction. Each Subscriber is also represented by an independent and/or equivalent node in the Network.

The term/phase “Appraising Subscriber” as used herein is intend to describe a merchant and/or dealer who is engaged in a transaction with a customer wherein the customer is trading in a product (also “used” or “existing product”) incident to a transaction for the purchase of a product from the Appraising Subscriber.

The phrase “On-Board Diagnostics” (also “OBD”) is intended to refer to a vehicle's self-diagnostic and reporting capability. OBD systems give the Appraising Subscriber access to the status of the various vehicle subsystems. OBD implementations use a standardized digital communications port to provide real-time data in addition to a standardized series of Diagnostic Trouble Codes (also DTCs) which allow one to rapidly identify and remedy malfunctions within the vehicle.

The phrase “Vehicle Specific Digital Profile” (also “VSHP”) as used herein is intended to describe a report, in the form of a retrievable digital file, and/or a printed copy of the digital file, that is associated with an appraised vehicle and includes product and technical information relative to an appraised vehicle offered for sale, wherein product and technical information includes a current inventory of the vehicle equipment based upon not only the manufacture “build ticket” for the vehicle, but also a list of accessories added after delivery to the distributor and up-to-date performance information at the time the vehicle is offered for sale into the wholesale or retail market.

### PREFERRED EMBODIMENTS

The System and Method of this invention are based upon a solicitation and execution of a bid and counter-offers for an appraised vehicle having a Vehicle Specific Digital Profile on a Hybrid Peer-to-Peer Network. This Vehicle Specific Digital Profile is created by a Network Member Subscriber utilizing a comprehensive appraisal check list incident to the purchase or trade-in of the vehicle offered for sale by the Member Subscriber. As described herein, the System and Method incorporates member specific profiles and preferences for selective routing of alerts/advisories to Network Subscribers, based Subscriber filter selection. For simplicity of expression and ease of understanding, the invention is depicted in reference to the automotive environment—a transaction for a consumer trade-in of a used vehicle and the real-time auction of the trade-in to Network Subscribers.

The illustrations and flow charts described hereinafter are representative of the preferred embodiments of this invention. Where a function or element is common to more than one illustration or flow chart, it is assigned a common descriptor.

### Wholesale Automobile Market

### a. Enrollment Process

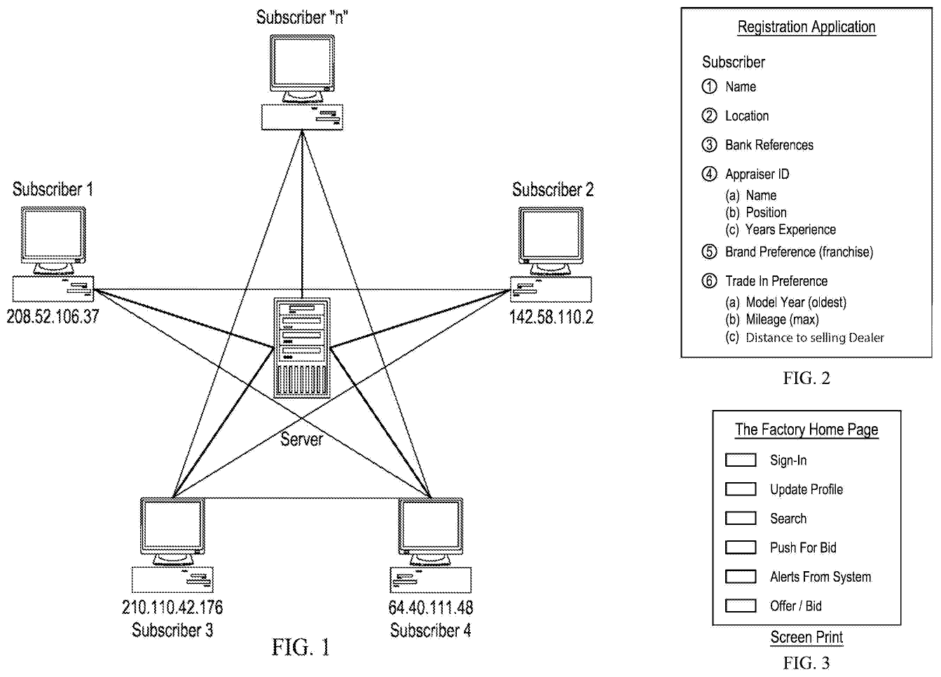

FIG. 1 depicts an overview of the architecture of the System of this invention based upon a Hybrid Peer-to-Peer (H-P2P) Network. The System is implemented by installation of a System Subscriber application on a Subscriber device capable of communication over the internet with a server hosted by a Cloud Service Provider.

In its simplest terms, a subscriber (also “System Clients” or “Clients”)
(a) Registers and deregisters its available goods and services to the Network Subscriber;
(b) Sends queries to the System to find/locate specific goods and services within the Network;
(c) Receives responses to its queries identifying peers (location) having the desired goods and services;
(d) Sends a query to solicit specific goods and services from among the peers on the Network;
(e) Receives responses to its queries from its peers in response to its request for specific goods and services;
(f) Receives requests from other peers for specific goods and services that may be available from it;
(g) Processes a peer request for specific goods and service it has; and
(h) Sends a response to a peer acknowledging the peer's request for specific goods and services in its inventory.

In this simple example, the System Host on the Hybrid P2P Network (the server) executes the queries and commands of the System Subscriber by
(a) registering and deregistering Subscribers' goods and services available on a relational database within the System;
(b) receiving and processing queries from Subscribers as to location (Peers) of available goods and services within the System;
(c) searching the relational database of the System for the location of available goods and services that match Subscriber queries; and,
(d) Responding to a Subscriber query with the location of the requested goods and services by sending information retrieved based upon a software application which is installed on a Subscriber's internet accessible device.

In the implementation, or adaptation, of the foregoing H-P2P Network to an automobile e-commerce auction model, the System Subscribers are “dealers” engaged in the retail sale of automobiles and the “transactions” involve negotiation of the wholesale sale and purchase of automobiles, including the initial appraisal and acceptance of a trade-in vehicle to consummate the transaction.

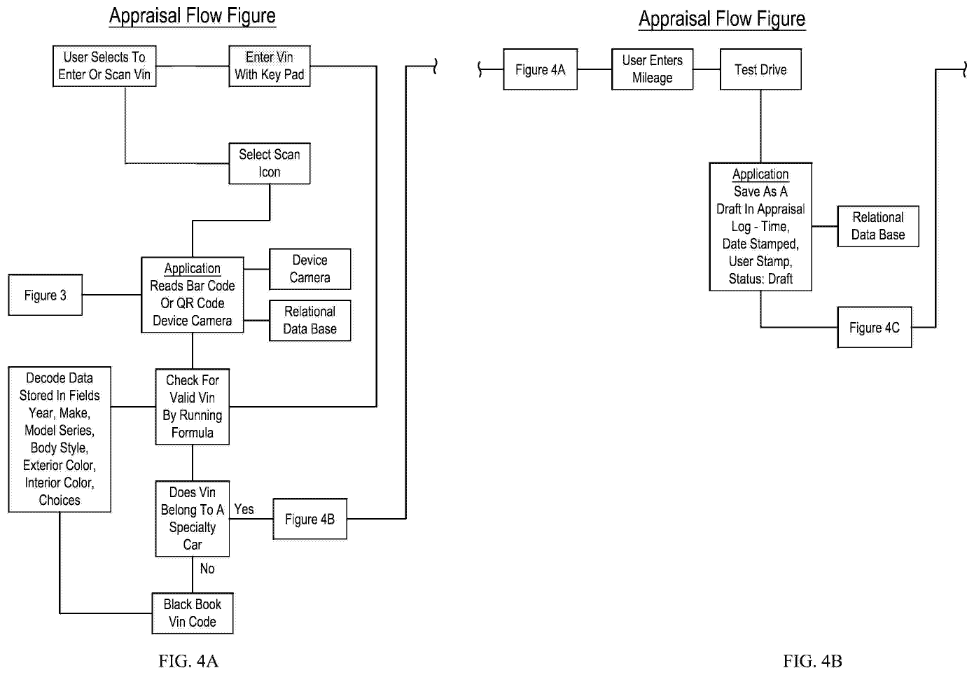

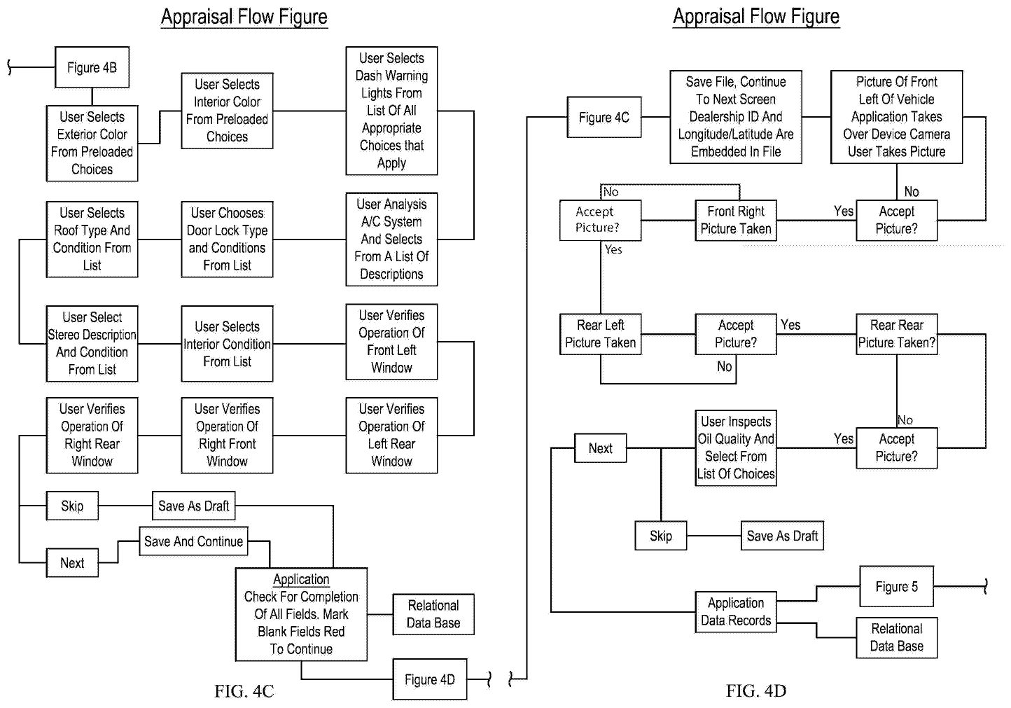

FIG. 2 depicts an enrollment process for Network Subscribers (dealers and support services (maintenance vendor and transport vendors)). Subscribers create an individual profile associated with their business. In the preferred embodiments of the system, the support services are passive registrants and are only accessed if a vehicle is taken in-trade. The Network Subscriber profile includes creation of a dealer identity, verification of licensure, financial information (banking) and DMS access. The Network Subscriber permits the enrolled Subscriber to pre-select (more accurately, pre-filter) information distributed on the Network and thereby create automatic alerts, or notifications, of the availability of a vehicle of interest. These filters can, for example, specify the make and model of a vehicle of potential interest, exclude “high mileage” vehicle, identify equipment preferences (automatic or manual transmission), engine/HP, etc.

Upon successful registration, an enrolled Network Subscriber is issued a personalized log-in code and a member ID number. The Subscriber registration is stored upon successful enrollment within a relational data base, accessible/hosted on an internet accessible Cloud network service provider. Each enrolled subscriber is integrated via the Cloud network service provider to accessory (third party) service providers, e.g. Black Book, NADA, AutoCheck, Credit card services and VEEM (Global Bank Transfer).

FIG. 3 depicts a SaaS application menu of the system of this invention as it appears on a computer (connected to the internet), or upon a mobile communication device (having internet access). The SaaS application menu permits a Subscriber to log-in to the Network and thereby select among the menu options available to Subscribers. Once logged in, a Subscriber automatically receives “alerts” to vehicles of interest offered by member Subscribers and can search the inventory of any Member Subscriber. The transactional process for offering and purchasing a vehicle is described hereinafter.

### b. Appraisal Process

In practice, a Network Member Subscriber involved in a retail transaction initially creates a verified trade-in appraisal of a retail customer product. The verified trade-in appraisal, created by the Network Member Subscriber, is based upon a standard industry checklist, photographs of interior and exterior views of the product and thereby divorced from subscriber biases concerning the trade-in. The Network Member Subscriber's appraisal is thus not subjectively influenced by the desirability of the trade-in for a specific subscriber demographic, or whether it is an acceptable addition to a merchant or dealer's existing inventory. In this system, merchants or dealers are thus inclined to consider and accept an otherwise unacceptable trade-in because another subscriber in the hybrid peer-to-peer network has expressed an interest in the trade-in or has agreed to the wholesale purchase of the item offered in trade. Accordingly, the merchants or dealers negotiating with retail customers have elevated levels of confidence in negotiation of the terms of the retail transaction, based upon the wholesale interest in the retail customer's trade-in, at the appraisal price.

A Vehicle Log is thereby created by the Member Subscriber (car dealer) upon a Relational Database with the System and maintained by the Network on the Cloud Service Provider for each of the customer vehicles submitted for appraisal to a Subscriber dealer. At each phase of the appraisal process, the Vehicle Log is updated as new information is added relative to an appraisal. The VIN is also “validated” (verified that it corresponds to the customer's vehicle & Black Book Codes); and the VIN is “decoded” to obtain information for a digital file, indicating the vehicle year, color and equipment. The appraisal also includes a series of pictures of the vehicle that are added to the Vehicle Log, from multiple perspectives (e.g. each quarter panel). These pictures reveal not only the vehicle color and not only the general condition of the vehicle, but also optional equipment that may not be evident from decoding of the VIN.

FIG. 4A to 4D are a series of flow charts depicting the creation of a digital vehicle profile by initially scanning (Phase I) a VIN of a customer vehicle, offered in trade, toward the purchase of a vehicle from a Member Subscriber (car dealer). More specifically, FIG. 4A depicts the validation of the vehicle information (by scanning the VIN and decoding data relative to the vehicle model year, model series, body style and color, including exterior and interior color). FIGS. 4B and 4C depict the collection of observed physical information by the Member Subscriber performing the appraisal. More specifically, in FIG. 4C the mileage of the vehicle is recorded and the observations/impressions of the vehicle's functional features (accessories) by the Member Subscriber performing the test drive. Digital data of the vehicle's operations and performance is also recorded in real-time; and may, at the option of the Member Subscriber performing the test drive, be included in the digital vehicle profile. The digital data from the OBD is transmitted by a Universal Asynchronous Receiver-Transmitter (UART) (e.g. a computer hardware device for asynchronous serial communication), in which the data format and transmission speed are configurable. The electric signaling levels and methods are handled by a driver circuit external to the UART. A UART is usually an individual (or part of an) integrated circuit (IC) used for serial communications over a computer or peripheral device serial port. One or more UART peripherals is commonly integrated in microcontroller chips. A related device, the universal synchronous and asynchronous receiver-transmitter (USART), also supports synchronous operation. ELM327 is a PIC microcontroller that has been customized with ELM Electronics' proprietary code that implements the testing protocols. FIG. 4D includes pictorial information of the vehicle, including photographs of any observed defects, damage or condition of the exterior of the vehicle relative to its “curb appeal”.

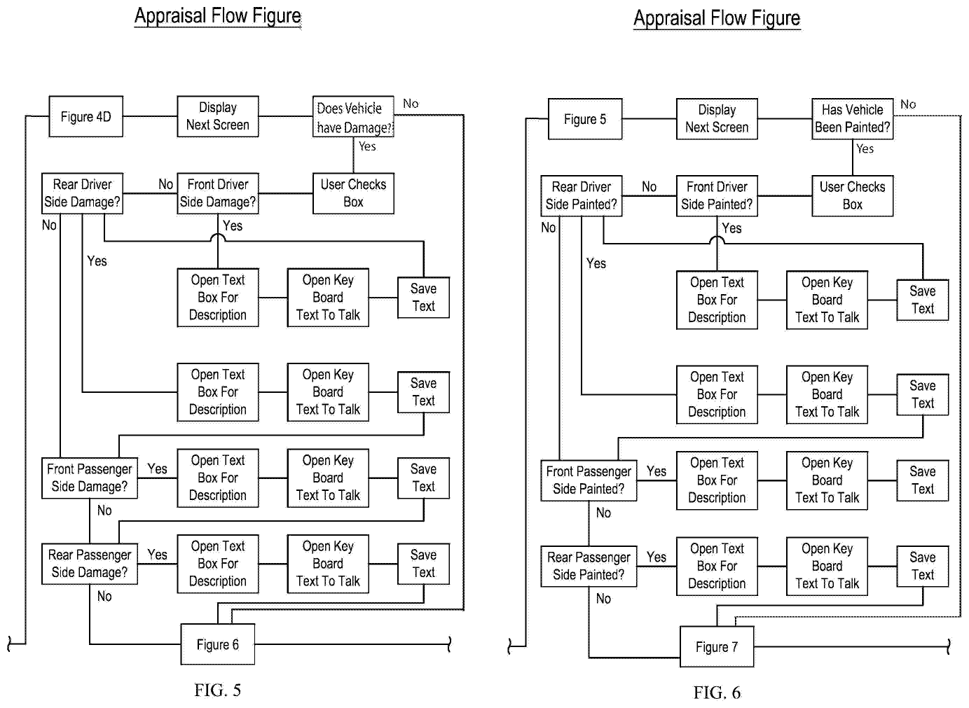

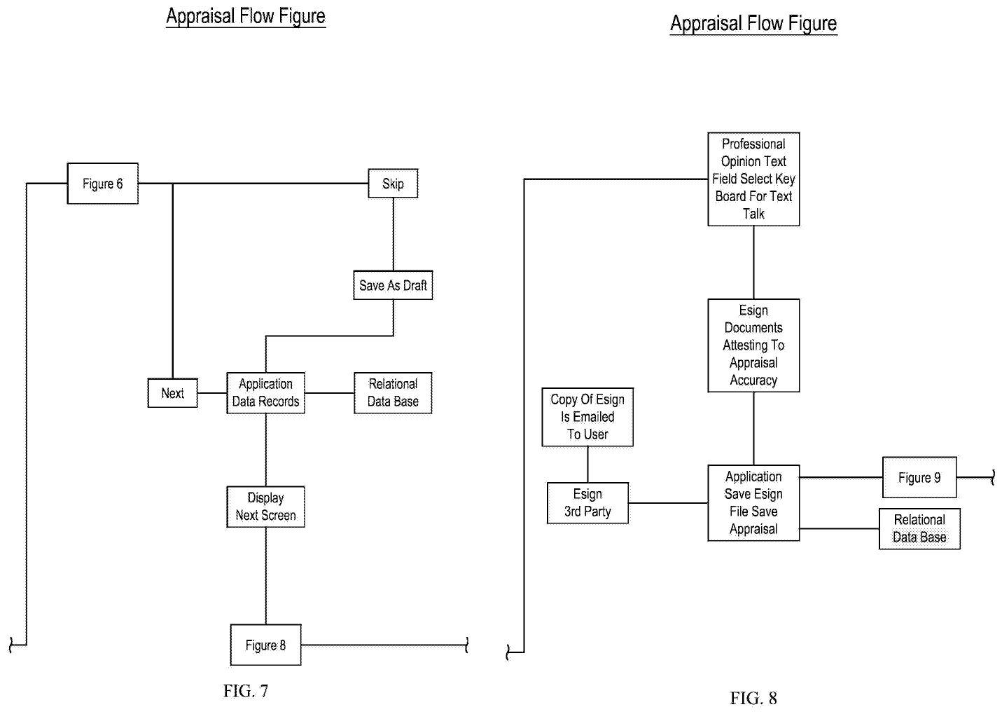

FIGS. 5 & 6 depict Phase II of the appraisal process wherein any defects and damage are noted. More specifically, FIGS. 5 & 6 depict the appraiser recording his personal observations/narrative from his static inspection of the vehicle systems and to validate the condition and operation of the vehicle's exterior and interior components (e.g., A/C, lights, window mechanisms, etc.).

FIGS. 7 & 8 depicts Phase III of the appraisal process, specifically, a compilation of the information from Phases I & II of the appraisal process wherein, preliminary to dissemination of the appraisal on the Network, and, thereafter, wholesale auction activity (bids and counter-offers) is reflected. More specifically, once the appraisal has been performed and validated, the appraisal is saved in a Vehicle Log of the Appraising Subscriber, for the specific vehicle. The vehicle specific appraisal is verified prior to distribution within the network. It is emphasized that unless the customer/owner of the vehicle accepts the valuation of his trade-in from the Appraising Subscriber, the Appraising Subscriber does not solicit offers (a Push for Bid) from Network Subscribers. The verified appraisal is however archived in the Vehicle Log of the Appraising Subscriber.

FIG. 8 depicts Phase IV of the appraisal process wherein the Appraising Subscriber finalizes, creates and saves the verified appraisal on the Network, preliminary to its release to Subscribers who have designated digital filters specific for the characteristics.

### c. E-Commerce Auction/Consummation of Trade-In Transaction

FIG. 9 depicts the commencement of the e-commerce negotiation auction by release and dissemination of the verified appraisal into the network, to thereby initiate transactions typical of a private wholesale auction wherein a Network Subscriber can bid for the appraised vehicle based upon its own needs (inventory) and local market conditions; and the Appraising Subscriber can accept the offer, counter, or reject the offer. The auction is initiated concurrent with the negotiation of the acceptance of the customer trade-in of the appraised vehicle.

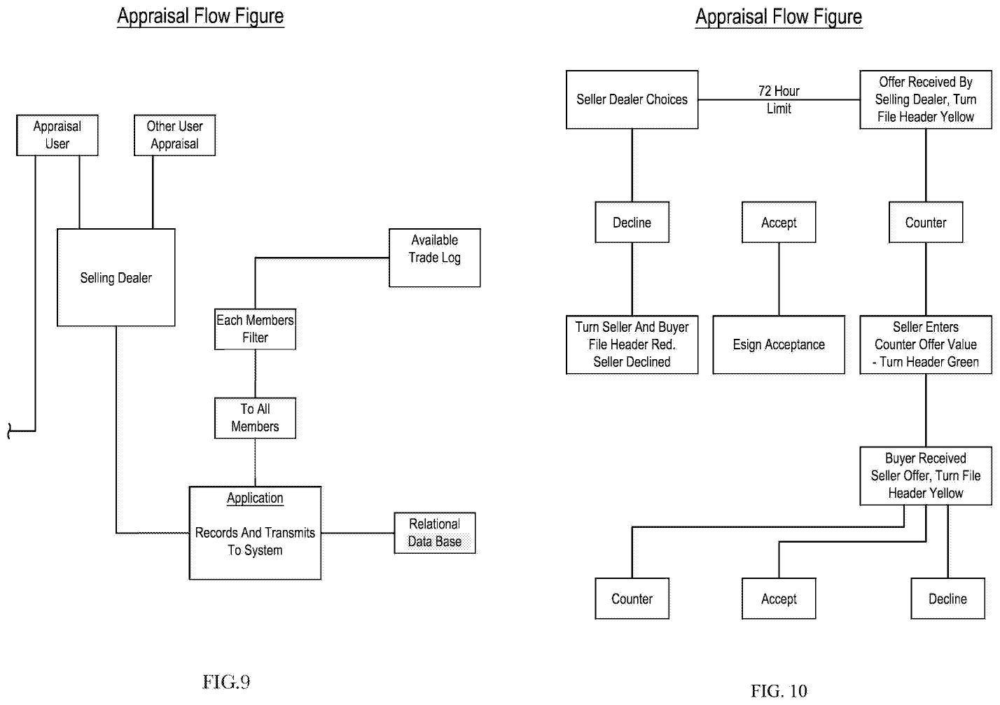

FIG. 10 depicts the bidding at the auction and assumes that the Appraising Subscriber has committed to accept a trade-in from the retail customer, (e.g. negotiated his private deal with the retail customer and the trade-in vehicle becomes the Appraising Subscriber's responsibility).

In one of the preferred embodiments, a Member Subscriber can elect to have the Network Virtual Sales Manager conduct automated auction of a vehicle with of an artificial (system) intelligence (AI) program resident on the Network. In this embodiment of the invention, the Virtual Sales Manager offers a vehicle for sale and solicits a Bid response. The offer to sell has a “reserve” price established by the seller and a set of rules within the artificial (system) intelligence (AI) program for evaluation and response to the Bid, also “acceptance system”. The Virtual Sales Manager implementation of the artificial (system) intelligence (AI) program, automatically counters or accepts incoming bids for a seller on the system, based upon the rules set established by artificial (system) intelligence (AI) program.

In a typical transaction, Seller signs on to the Virtual Sales Manager system page, by setting a Reserve price on a vehicle he or she wishes to sell. To do this the seller completes his

1 [symbol] Setting of Reserve Price, based upon the Vehicle Specific Digital Profile; and

2 [symbol] Signing a sales agreement (commitment to sell) based upon the Reserve Price.

Once there is a commitment to sell the vehicle, the system informs all member that this vehicle has a reserve by placing a red “R” on the file header display of the Virtual Sales Manager system page. The Virtual Sales Manager system will then respond automatically to every bid placed by any buyer on the system on this vehicle. Every Bid below reserve is countered, in real time, by an incremental increase (“Bump”) in the Seller's offer to sell above reserve. This new Seller offer is a “Buy It Now” price. Acceptance of this counter offer by a buyer ends the sale, and the buyer has purchased the vehicle. Each buyer has a unique counter that may or may not be the same.

If an offer is made above Reserve, the system waits, or times out, for 30 minutes for other offers. If other offers are received that are higher than the held high bid, the clock is reset, and the lower bid countered. Counter offers are set by the system as the higher of Reserve Plus Bump, or Highbid Plus Bump. A Bump is a predetermined value based on the price of the vehicle, which is the higher of Reserve or Highbid.

A Sale is achieved when the first of the following happens (a) a Buyer accepts the Seller's “buy it now” counter price, or (b) the bid clock expires on a Highbid over Reserve. Once a sale occurs by the above means, all other offers or bids are locked out. The sale will run until the seller removes the reserve, or the vehicle sells by any one of the above means.

In the absent of an acceptable wholesale bid by a Network Subscriber, the trade-in is added to the inventory of the Appraising Subscriber. Thereafter, the appraised vehicle is searchable on the Network in the Network Vehicle Log and is accessible on the Network.

In one of the alternative embodiments of this invention, the Network, over time, creates its own version of a wholesale directory, or Black Book, which can be used as a basis for comparison for future transactions involving the same of a comparable vehicle.

It is emphasized that the value placed upon the customer vehicle by the Appraising Subscriber is not accessible on the Network after its solicitation of bids on the network. Similarly, the vehicle specific profile is not associated with the offers and counter-offers for the vehicle accessible by Network subscribers—including offers and counter-offers by the Appraising Subscriber.

This system has particular applications to businesses which typically accept a trade-in (e.g. jewelry or used car) incident and preliminary to a retail customer transaction for the purchase of products from a merchant or dealer of comparable products (e.g. jewelry store or car dealer). Unlike current so-called jewelry exchanges (e.g. Polygon, Repnet), the Network members independently search, locate, and negotiate directly with the source of gems or jewelry; and can move inventory to each other members, as markets change (seasonal businesses). The system of this invention also provides an attractive competitive marketplace for salvage yards and used parts suppliers for the competitive disposal of wrecked automobiles at auction.

The network and system of this invention has been exemplified by reference to a specific application thereof in the automotive marketplace and is not intended to define the metes and bounds of the invention which is set forth in the following claims.

What is claimed is:

1. In a system for creating an on-line interactive marketplace on a computer implemented network, for solicitation of network member participation in an auction, to effect the execution of wholesale transactions among network members, for the sale and purchase of used, or existing products,—collectively “products”—between members, which are taken in trade from a potential customer, toward the purchase of a product from a network member or subscriber, wherein the improvement comprises:
A. Providing a computer implemented application for subscriber access to a network having a community of interest in the wholesale sale and purchase of a customer's product to be taken in trade toward the purchase of a product from a subscriber;
B. A Product module, within said application, for subscriber creation of a customer's product specific appraisal, for a product to be taken in trade by a subscriber in a transaction with a consumer, said customer's product specific appraisal having product specific information derived from said customer's product, preliminary to said transaction with said consumer, wherein said customer's product specific information includes:
(1) Information associated with objective information characteristic of the physical and/or operational features of said customer's product,
(2) Information derived from an inspection and subjective impression of said customer's product by a qualified appraiser;
C. Establishing a customer's product specific appraisal log upon said network for said product to be taken in trade, said log being searchable and accessible to subscribers to said network;
D. Disseminating said customer's product specific appraisal, in a real-time, to network subscribers, having profile preferences for said customer's product, concurrent with negotiating a transaction involving a trade-in for said customer's product; and
E. Concluding said transaction involving said trade-in, wherein said customer's product is transferred from said customer to a subscriber on said network.

2. In the system of claim 1, wherein said subscriber network is a peer-to-peer hybrid network, and each subscriber is independent of one another on said network.

3. In the system of claim 1, wherein only subscribers having profile preferences for said customer's product receive said customer's product specific appraisal.

4. In the system of claim 1, wherein said customer's product specific appraisal is retained within said system.

5. In the system of claim 1, wherein said customer's product is appraised by at least one additional subscriber.

6. In a system for creating an on-line interactive marketplace on a computer implemented network, for solicitation of network member participation in the auction, to effect the execution of wholesale transactions among network members, for the sale and purchase of used vehicles, between members, which are taken in-trade from a potential customer, toward the purchase of a vehicle from a network member or subscriber, wherein the improvement comprises:
A. Providing a computer implemented application for subscribers access to a network having a community of interest in the wholesale sale and purchase of a customer's vehicle to be taken in trade toward the purchase of a vehicle from a subscriber;
B. A Product module, with said application, for subscriber creation of a product specific appraisal, for a vehicle to be taken in trade by a subscriber in a transaction with a consumer, said vehicle specific appraisal having product specific information derived from said customer's vehicle, preliminary to said transaction with said consumer, wherein said product specific appraisal includes:
(1) Information associated with objective information characteristic of physical and/or operational features of said customer's vehicle,
(2) Information obtainable from said customer's vehicle VIN number; and
(2) Information derived from an inspection and subjective impression of said customer's vehicle by a qualified appraiser, including a test drive of the used vehicle;
C. Establishing a vehicle product specific appraisal log upon said network for said customer's vehicle to be taken in trade, said log being searchable and accessible to subscribers to said network;
D. Disseminating said customer's vehicle specific appraisal, in a real-time, to network subscribers, having profile preferences for said vehicle, concurrent with negotiating a consumer transaction involving a trade-in for said customer's vehicle; and
E. Concluding said consumer transaction involving said trade-in, wherein said customer's vehicle is transferred from said customer to a subscriber on said network.

7. In the system of claim 6, wherein said subscriber network is a Peer-to-peer hybrid network, and each subscriber is independent of one another on said network.

8. In the system of claim 6, wherein only subscribers having profile preferences for said used vehicles receive said used vehicles specific appraisal.

9. In the system of claim 6, wherein said used vehicles appraisal is retained within said system.

10. In the system of claim 6, wherein said used vehicles is appraised by at least one additional subscriber.

11. In a system for creating an on-line interactive marketplace on a computer implemented network, for solicitation of network member participation in the auction, to effect the execution of wholesale transactions among network members, for the sale and purchase of adornments, collectables and/or spirits (e.g. jewelry, coins, vintage cars, work of art and wines), collectively “luxury item”, between members, which are taken in-trade from a potential customer, toward the purchase of a luxury items from a network member or subscriber, wherein the improvement comprises:
A. Providing a computer implemented application for subscribers access to a network having a community of interest in the wholesale sale and purchase of a luxury item to be taken in trade toward the purchase of a luxury items from a subscriber;
B. A Product module, within said application, for subscriber creation of a luxury item specific appraisal, for said luxury item to be taken in trade by a subscriber in a transaction with a consumer, said luxury item specific appraisal having product specific information derived from said customer's luxury item, preliminary to said transaction with said consumer, wherein said product specific information includes:
1. Information associated with objective information characteristic of the physical and/or operational features of said luxury item,
2. Information derived from an inspection and subjective impression of said luxury item by a qualified appraiser, including a test drive of the used vehicle;
C. Establishing a luxury item specific appraisal log upon said network for said luxury item to be taken in trade, said log being searchable and accessible to subscribers to said network;
D. Disseminating said luxury item specific appraisal, in a real-time, to network subscribers, having profile preferences for said luxury item, concurrent with negotiating a consumer transaction involving a trade-in for said luxury item; and
E. Concluding said consumer transaction involving said trade-in of said luxury item, wherein said luxury item is transferred from said consumer to a subscriber on said network.

12. In the system of claim 11, wherein said subscriber network is a Peer-to-peer hybrid network, and each subscriber is independent of one another on said network.

13. In the system of claim 11, wherein only subscribers having profile preferences for said luxury item receive said customer's product specific appraisal.

14. In the system of claim 11, wherein said luxury item specific appraisal is retained within said system.

15. In the system of claim 11, wherein said luxury item is appraised by at least one additional subscriber.

16. In the method of claim 16, wherein said customer's product is vintage wine or spirit.

17. In a method for conducting a real-time auction of a subscriber customer product, on a computer-implemented network between network subscribers, incident to a trade-in of said customer product, for a product available from a subscriber, wherein the improvement comprises:
A. Providing a network of subscribers having a community of interest in the wholesale sale and purchase of a customer product to be taken in trade toward the purchase of a customer product from a subscriber
B. Creating a verified appraisal of said customer product to be taken in trade by a subscriber in a transaction with said customer, said customer product specific appraisal having customer product specific information derived from said customer product, preliminary to said transaction with said consumer, wherein said customer product specific information includes:
3. Information associated with objective information characteristic of the physical and/or operational features of said luxury item,
4. Information derived from an inspection and subjective impression of said luxury item by a qualified appraiser;
C. Establishing a customer product specific appraisal log upon said network for said customer product to be taken in trade, said log being searchable and accessible to subscribers to said network;
D. Disseminating said customer product specific appraisal, in a real-time, to network subscribers, having profile preferences for said customer product, concurrent with negotiating a transaction with said customer involving a trade-in for said customer product; and
E. Concluding said customer transaction involving said trade-in of said customer product, wherein said luxury item is transferred from said customer to a subscriber on said network.

18. In the method of claim 16, wherein said subscriber network is a Peer-to-peer hybrid network, and each subscriber is independent of one another on said network.

19. In the method of claim 16, wherein only subscribers having profile preferences for said customer's product receive said customer's product specific appraisal.

20. In the method of claim 16, wherein said customer's product specific appraisal is retained within said system.

21. In the method of claim 16, wherein said customer's product is appraised by at least one additional subscriber.

22. In the method of claim 16, wherein said customer's product is vehicle.

23. In the method of claim 16, wherein said customer's product is jewelry.

24. In the method of claim 16, wherein said customer's product is a work of art.

25. In the method of claim 16, wherein said customer's product is a coin.
